(19) United States
(12) Patent Application Publication
(10) Pub. No.: US 2011/0194824 A1
(43) Pub. Date: Aug. 11, 2011

(54) CABLE ASSEMBLY HAVING FLOATABLE OPTICAL MODULE

(75) Inventor: HOWARD WALLACE ANDREWS, Hummelstown, PA (US)

(73) Assignee: HON HAI PRECISION INDUSTRY CO., LTD., Tu-Cheng (TW)

(21) Appl. No.: 12/701,632

(22) Filed: Feb. 8, 2010

(51) Int. Cl. G02B 6/36

(52) U.S. Cl. 385/93; 385/92; 385/100

(57) ABSTRACT

A cable assembly (100) includes an insulative housing (2) defining a mounting cavity (221); an optical module (5) accommodated in the mounting cavity and capable of moving therein along a front-to-back direction; at least one fiber (6) coupled to the optical module; and two elastomeric members (9) integrally formed with the optical module and rearwardly extending therefrom to press onto the insulative housing.

### CROSS-REFERENCE TO RELATED APPLICATIONS

This application is related to U.S. patent application Ser. No. 11/818,100, filed on Jun. 13, 2007 and entitled “EXTENSION TO UNIVERSAL SERIAL BUS CONNECTOR WITH IMPROVED CONTACT ARRANGEMENT”, and U.S. patent application Ser. No. 11/982,660, filed on Nov. 2, 2007 and entitled “EXTENSION TO ELECTRICAL CONNECTOR WITH IMPROVED CONTACT ARRANGEMENT AND METHOD OF ASSEMBLING THE SAME”, and U.S. patent application Ser. No. 11/985,676, filed on Nov. 16, 2007 and entitled “ELECTRICAL CONNECTOR WITH IMPROVED WIRE TERMINATION”, and U.S. patent application Ser. No. 12/626,632 filed on Nov. 26, 2009 and entitled “CABLE ASSEMBLY HAVING POSITIONING MEANS SECURING FIBER THEREOF”, and U.S. patent application Ser. No. 12/626,631 filed Nov. 26, 2009 and entitled “CABLE ASSEMBLY HAVING POSITIONING MEANS SECURING FIBER THEREOF”, all of which have the same assignee as the present invention.

### BACKGROUND OF THE INVENTION

1. Field of the Invention

The present invention relates to a cable assembly, more particularly to a cable assembly capable of transmitting optical signal.

2. Description of Related Art

Personal computers (PC) use a variety of techniques for providing input and output. Universal Serial Bus (USB) is a serial bus standard to the PC architecture with a focus on computer telephony interface, consumer and productivity applications. The design of the USB is standardized by the USB Implementers Forum (USB-IF), an industry standard body incorporating leading companies from the computer and electronic industries. USB can connect peripherals such as mouse devices, keyboards, PDAs, gamepads and joysticks, scanners, digital cameras, printers, external storage, networking components, etc. For many devices such as scanners and digital cameras, USB has become the standard connection method.

USB supports three data rates: 1) A Low Speed rate of up to 1.5 Mbit/s (187.5 KB/s) that is mostly used for Human Interface Devices (HID) such as keyboards, mice, and joysticks; 2) A Full Speed rate of up to 12 Mbit/s (1.5 MB/s). Full Speed was the fastest rate before the USB 2.0 specification and many devices fall back to Full Speed. Full Speed devices divide the USB bandwidth between them in a first-come first-served basis and it is not uncommon to run out of bandwidth with several isochronous devices. All USB Hubs support Full Speed; 3) A Hi-Speed rate of up to 480 Mbit/s (60 MB/s). Though Hi-Speed devices are advertised as “up to 480 Mbit/s”, not all USB 2.0 devices are Hi-Speed. Hi-Speed devices typically only operate at half of the full theoretical (60 MB/s) data throughput rate. Most Hi-Speed USB devices typically operate at much slower speeds, often about 3 MB/s overall, sometimes up to 10-20 MB/s. A data transmission rate at 20 MB/s is sufficient for some but not all applications. However, under a circumstance transmitting an audio or video file, which is always up to hundreds MB, even to 1 or 2 GB, currently transmission rate of USB is not sufficient. As a consequence, faster serial-bus interfaces are being introduced to address different requirements. PCI Express, at 2.5 GB/s, and SATA, at 1.5 GB/s and 3.0 GB/s, are two examples of High-Speed serial bus interfaces.

From an electrical standpoint, the higher data transfer rates of the non-USB protocols discussed above are highly desirable for certain applications. However, these non-USB protocols are not used as broadly as USB protocols. Many portable devices are equipped with USB connectors other than these non-USB connectors. One important reason is that these non-USB connectors contain a greater number of signal pins than an existing USB connector and are physically larger as well. For example, while the PCI Express is useful for its higher possible data rates, a 26-pin connector and wider card-like form factor limit the use of Express Cards. For another example, SATA uses two connectors, one 7-pin connector for signals and another 15-pin connector for power. In essence, SATA is more useful for internal storage expansion than for external peripherals.

The existing USB connectors have a small size but low transmission rate, while other non-USB connectors (PCI Express, SATA, et al) have a high transmission rate but large size. Neither of them is desirable to implement modern high-speed, miniaturized electronic devices and peripherals. To provide a connector with a small size and a high transmission rate for portability and high data transmitting efficiency is much more desirable.

In recent years, more and more electronic devices are adopted for optical data transmission. It may be a good idea to design a connector which is capable of transmitting an electrical signal and an optical signal. Design concepts are already common for such a type of connector which is compatible of electrical and optical signal transmission. The connector includes metallic contacts assembled to an insulated housing and several optical lenses bundled together and mounted to the housing also. A kind of hybrid cable includes wires and optical fibers that are respectively attached to the metallic contacts and the optical lenses.

However, optical lenses are unable to be floatable with regard to the housing. They are not accurately aligned with, and optically coupled to counterparts, if there are some errors in manufacturing process.

### BRIEF SUMMARY OF THE INVENTION

Accordingly, an object of the present invention is to provide a cable assembly has a floatable optical module.

In order to achieve the above-mentioned object, a cable assembly in accordance with present invention is comprised of: an insulative housing defining a mounting cavity; an optical module accommodated in the mounting cavity and capable of moving therein along a front-to-back direction; at least one fiber coupled to the optical module; and two elastomeric/flexible members integrally formed with the optical module and rearwardly extending therefrom to press onto the insulative housing.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a cable assembly in accordance with the first embodiment of the present invention;

FIG. 2 is a partially assembled view of the cable assembly of FIG. 1;

FIG. 3 is a top side view of FIG. 2;

FIG. 4 is an exploded, perspective view of FIG. 2;

FIG. 5 is similar to FIG. 4, but viewed from another aspect;

FIG. 6 is a partially assembled view of a cable assembly in accordance with a second embodiment of the present invention; and

FIG. 7 is an exploded, perspective view of FIG. 6.

### DETAILED DESCRIPTION OF THE PREFERRED EMBODIMENTS

In the following description, numerous specific details are set forth to provide a thorough understanding of the present invention. However, it will be obvious to those skilled in the art that the present invention may be practiced without such specific details.

Reference will be made to the drawing figures to describe the present invention in detail, wherein depicted elements are not necessarily shown to scale and wherein like or similar elements are designated by same or similar reference numeral through the several views and same or similar terminology.

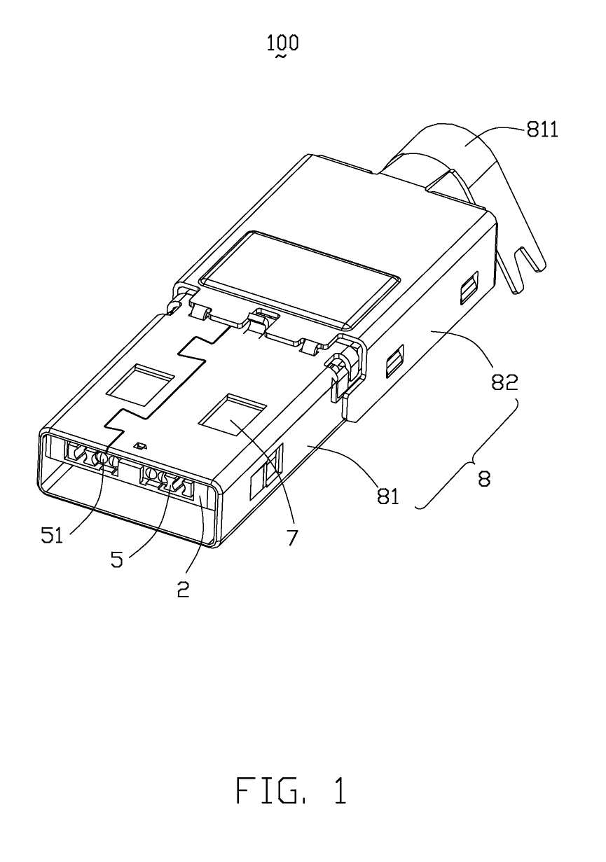

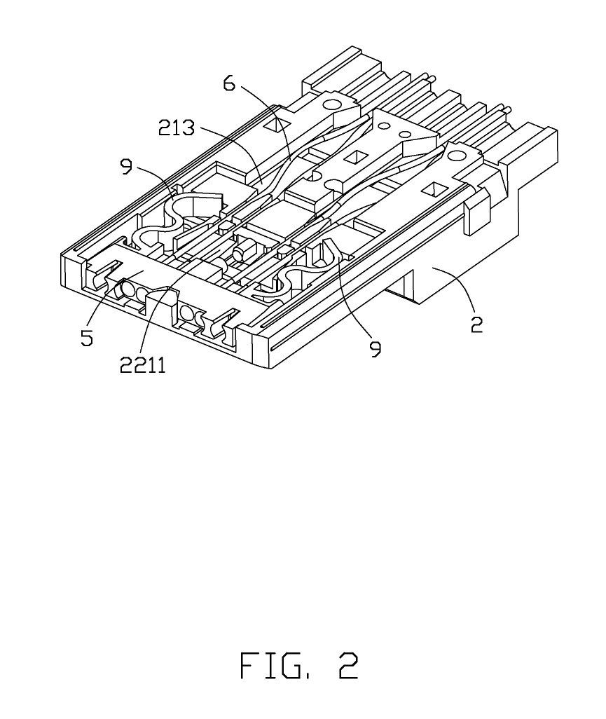

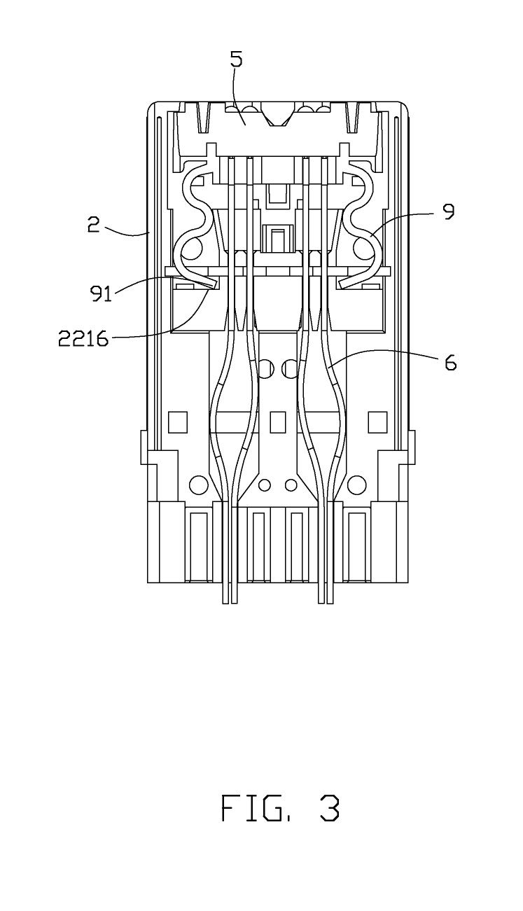

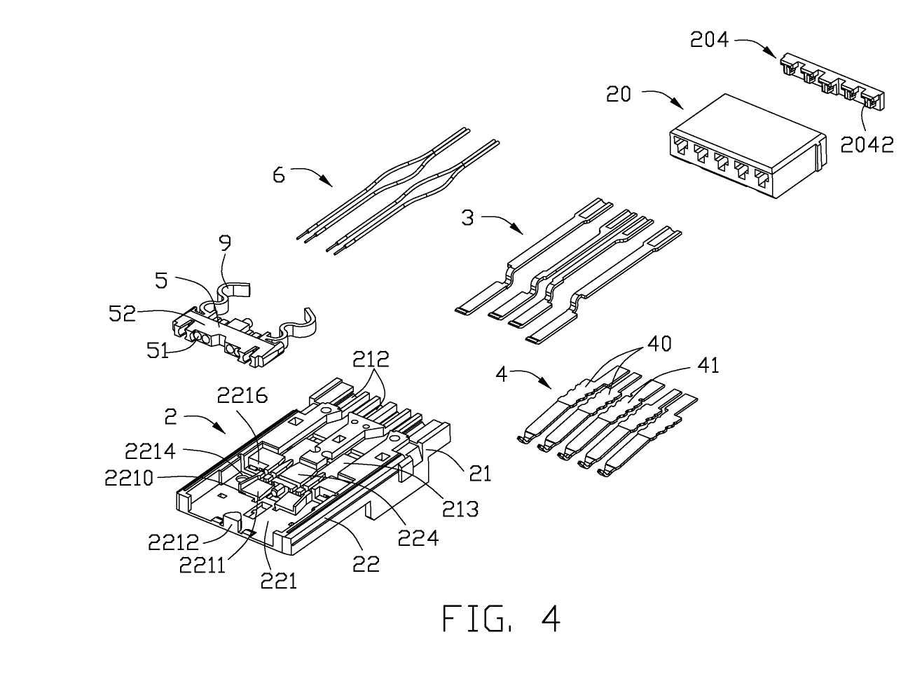

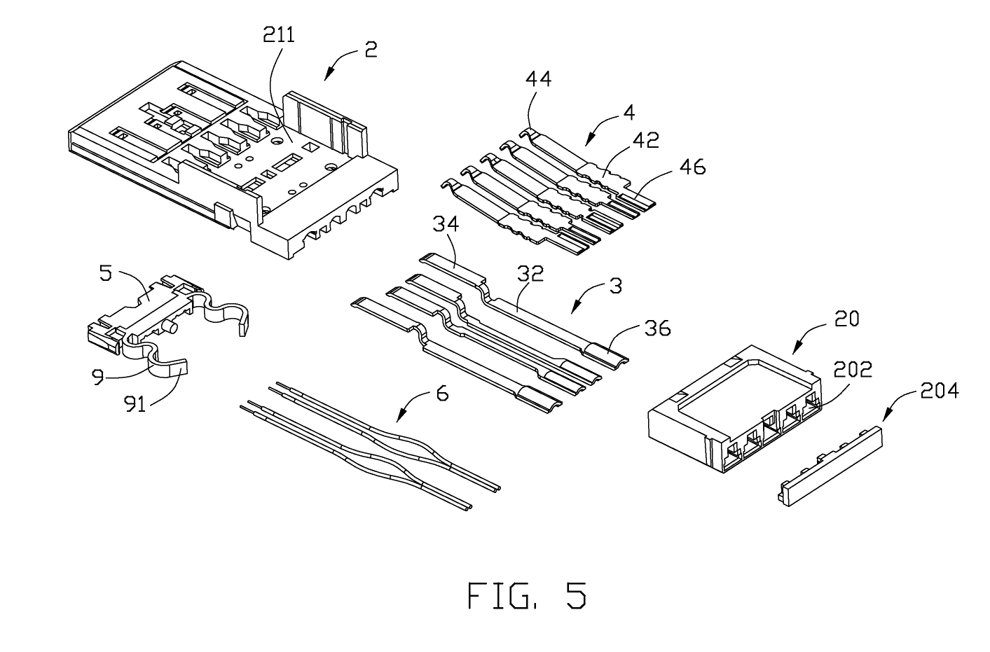

Referring to FIGS. 1-5, a cable assembly 100 in accordance with the first embodiment of the present invention is disclosed. The cable assembly 100 comprises an elongated insulative housing 2 extending along a front-to-back direction, a set of first contacts 3, a set of second contacts 4 and an optical modules 5 supported by the insulative housing 2, and a number of fibers 6 coupled to the optical module 5. The cable assembly 1 further comprises a metal shell 8 and two elastomeric/flexible members 9 integrally formed with the optical module 5. The elastomeric members 9 are capable of biasing the optical modular 5 along the front-to-back direction. Detail description of these elements and their relationship and other elements formed thereon will be detailed below.

The insulative housing 2 includes a base portion 21 and a tongue portion 22 extending forwardly from the base portion 21. A cavity 211 is recessed upwardly from a bottom surface (not numbered) of the base portion 21. A mounting cavity 221 is recessed downwardly from a top surface of the tongue portion 22. A stopping member 2212 is formed in a front portion of the mounting cavity 221. Two L-shaped platforms 2210 are located in a middle segment of a rear portion of the mounting cavity 221, with a fiber channel 2211 formed there between. Two mounting slots 2214 each is formed between the L-shaped platform 2210 and a corresponding lateral side of the tongue portion 22. A depression 224 is defined in a rear portion of the tongue portion 22 and disposed behind the fiber channel 2211. A number of contact slots 212 are defined in an upper segment of a rear portion of the base portion 21. Two fiber grooves 213 are defined in the base portion 21 and extend along the front-to-back direction, pass the depression 224 and communicate with the fiber channel 2211 and the mounting cavity 221.

The set of first contacts 3 have four contact members arranged in a row along the transversal direction. Each first contact 3 substantially includes a planar retention portion 32 supported by a bottom surface of the cavity 211, a mating portion 34 raised upwardly and extending forwardly from the retention portion 32 and disposed in a depressed area 226 of the lower section of the front segment of the tongue portion 22, and a tail portion 36 extending rearward from the retention portion 32 and accommodated in the terminal slots 212.

The set of second contacts 4 have five contact members arranged in a row along the transversal direction and combined with an insulator 20. The set of second contacts 4 are separated into two pairs of signal contacts 40 for transmitting differential signals and a grounding contact 41 disposed between the two pair of signal contacts 40. Each second contact 4 includes a planar retention portion 42 received in corresponding groove 202 in the insulator 20, a curved mating portion 44 extending forward from the retention portion 42 and disposed beyond a front edge of the insulator 20, and a tail portion 46 extending rearward from the retention portion 42 and disposed behind a back side of the insulator 20. A spacer 204 is assembled to the insulator 20, with a number of ribs 2042 thereof inserted into the grooves 202 to position the second contacts 4 in the insulator 20.

The insulator 20 is mounted to the cavity 211 of the base portion 21 and press onto retention portions 32 of the first contacts 3, with mating portions 44 of the second contacts 4 located behind the mating portions 34 of the first contacts 3 and above the up surface of the tongue portion 22, the tail portions 46 of the second contacts 4 arranged on a bottom surface of the rear segment of the base portion 21 and disposed lower than the tail portions 36 of the first contacts 3.

The optical module 5 includes four lens members 51 arranged in juxtaposed manner and enclosed by a holder member 52 and retained in the mounting cavity 221. In addition, the two elastomeric members 9 are of serpent shaped and integrated with the holder member 52 and projected rearward. The two elastomeric members 9 are spaced apart from each other along the transversal direction so as to provide a balanced pushing force to prevent tilting of the optical module 5.

The optical module 5 is put in the mounting cavity 221 and the elastomeric members 9 are respectively accommodated in the mounting slots 2214, with a free end 91 of the elastomeric member 9 constantly pressing onto a back side 2216 of the mounting cavity 221. The stopping member 2212 can prevent the optical module 5 sliding away from the mounting cavity 221.

Four fibers 6 are separated into two groups and enter a rear section of the mounting cavity 221, through the fiber grooves 213 and the fiber channel 2211 and are coupled to the four lens 51, respectively.

The metal shell 8 comprises a first shield part 81 and a second shield part 82. The first shield part 81 is assembled to a rear segment of the second shield part 82 to enclose the insulative housing 2 and the optical module 5 therein. A cap member 7 is mounted to the depression 224 and disposed underneath two windows (not numbered) defined in the second shield part 82.

The cable assembly may have a hybrid cable which includes fibers 6 for transmitting optical signals and copper wires (not shown) for transmitting electrical signals. The copper wires are terminated to the first contacts 3 and the second contacts 4. A cable holder member 811 is crimped onto the cable to enhance mechanical interconnection.

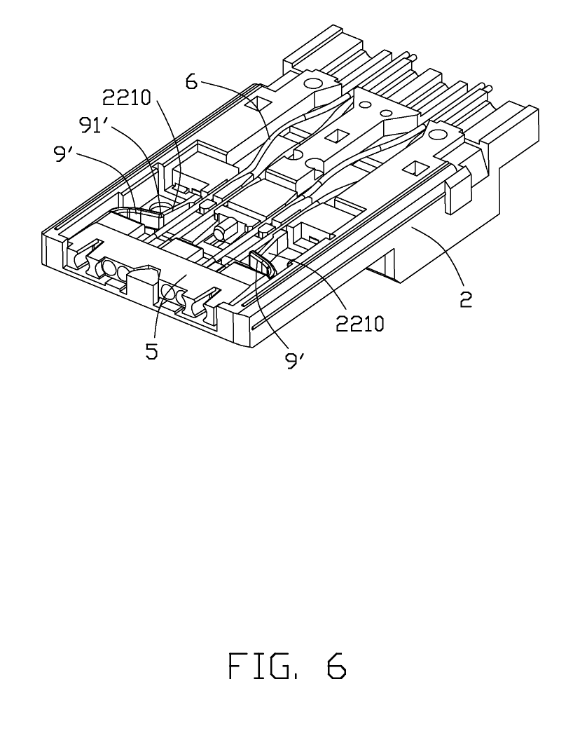

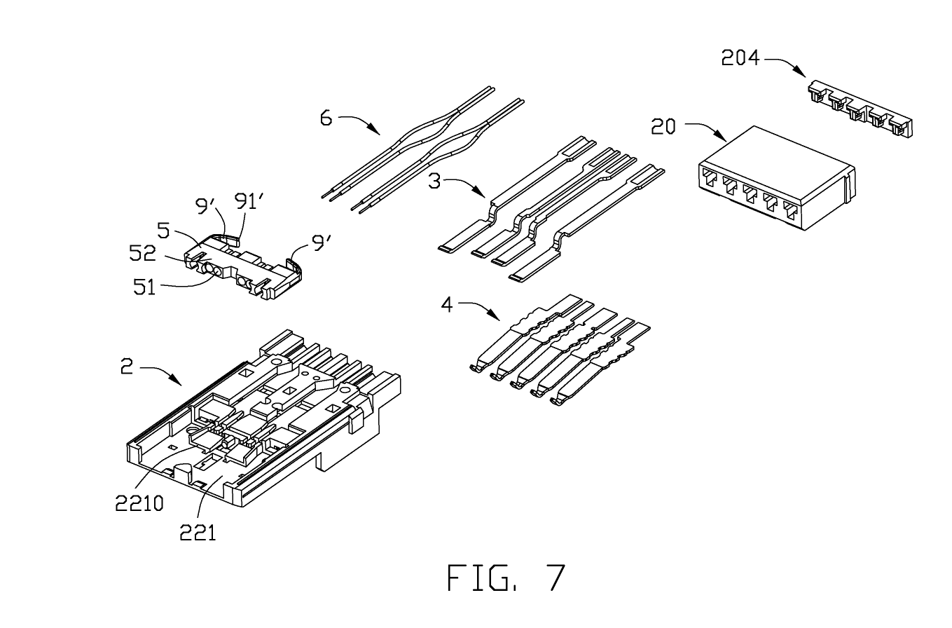

Referring to FIGS. 6-7 and in conjunction with FIGS. 1-5, a cable assembly in accordance with the second embodiment of the present invention is disclosed. The cable assembly of the second embodiment is similar to the cable assembly 100 of the first embodiment, excepted that two elastomeric/flexible members 9′ are different from the elastomeric members 9 in the cable assembly 100. The two elastomeric members 9′ are integrally formed with an optical module 5 and inwardly deflect toward each other.

The optical module 5 is put in a mounting cavity 221 and the elastomeric members 9′ are respectively accommodated in the mounting cavity 221, with a free end 91′ of the elastomeric member 9 constantly pressing onto a front edge of the L-shaped platforms 2210. The stopping member 2212 can prevent the optical module 5 sliding away from the mounting cavity 221. Other elements and their relations of the cable assembly 100′ is similar to the corresponding elements and their relations of the cable assembly 100, and detailed description is omitted hereby.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

What is claimed is:

1. A cable assembly, comprising:
an insulative housing defining a mounting cavity;
an optical module accommodated in the mounting cavity and capable of moving therein along a front-to-back direction;
at least one fiber coupled to the optical module; and
two elastomeric members integrally formed with the optical module and rearwardly extending therefrom to press onto the insulative housing.

2. The cable assembly as claimed in claim 1, wherein the two elastomeric members are serpent shaped.

3. The cable assembly as claimed in claim 1, wherein two mounting slots are respectively located in a rear portion of the mounting cavity and arranged at opposite sides thereof, and the two elastomeric members are respectively accommodated in the mounting slots.

4. The cable assembly as claimed in claim 3, wherein the elastomeric member has a free end pressing onto a back side of the mounting cavity.

5. The cable assembly as claimed in claim 3, wherein a fiber channel is disposed between the two mounting slots and a fiber groove is defined in the insulative housing and disposed behind and communicating with the fiber channel.

6. The cable assembly as claimed in claim 5, wherein the at least one fiber passes through the fiber groove and the fiber channel to connect with the optical module.

7. The cable assembly as claimed in claim 6, wherein the fiber channel is broader than the fiber groove.

8. The cable assembly as claimed in claim 1, further comprising a plurality of contacts supported by the insulative housing.

9. The cable assembly as claimed in claim 8, wherein the contacts are divided into a set of first contacts and a set of second contacts, and mating portions of the first contacts are disposed in front of mating portions of the second contacts.

10. The cable assembly as claimed in claim 9, wherein the mating portions of the first contacts and the second contacts and the optical module are arranged at opposite sides of the insulative housing along an up-to-down direction.

11. A cable assembly, comprising:
an insulative housing defining a mounting cavity;
an optical module accommodated in the mounting cavity and capable of moving therein along a front-to-back direction;
a plurality of fibers coupled to the optical module; and
two flexible members unitarily extending rearwardly from the optical module and disposed toward each other.

12. The cable assembly as claimed in claim 11, wherein two platforms are located in a rear portion of the mounting cavity, and the flexible members are respectively press onto front edges of the two platforms.

13. The cable assembly as claimed in claim 12, wherein the two platforms are L-shaped, and a fiber channel is formed between the two platforms.

14. The cable assembly as claimed in claim 11, wherein the optical module includes a holder member and plurality of lens members arranged in juxtaposed manner and enclosed by the holder member.

15. The cable assembly as claimed in claim 14, wherein the fibers are respectively connected to the lens.

16. The cable assembly as claimed in claim 11, further comprising a metal shell enclosing the insulative housing.

17. A cable connector assembly comprising:
an insulative housing defining an electrical mating port and an optical mating port;
an optical module disposed on the optical mating port;
said optical module equipped with lenses in a main body of the optical module, and further integrally formed with a pair of flexible members which extend rearward away from the main body with abutments to abut against other device for urging the main body of the optical module forward so as to provide resiliency of the optical module in a front-to-back direction; wherein
the pair of abutments are spaced from each other and by two sides of a center line of the optical module.

18. The cable connector assembly as claimed in claim 17, wherein said optical module further includes a set of optical fibers extending from the corresponding lenses rearwardly between said pair of flexible members in a transverse direction perpendicular to said front-to-back direction.

19. The cable connector assembly as claimed in claim 18, wherein a distance between said two pair of abutments is larger than one third of a dimension of said optical module in the transverse direction.

20. The cable connector assembly as claimed in claim 18, wherein said optical module is received within a mounting cavity formed in the housing.
